(19) United States
(12) Patent Application Publication
(10) Pub. No.: US 2025/0069086 A1
(43) Pub. Date: Feb. 27, 2025

(54) ASYNCHRONOUS GENERATION AND PRESENTATION OF CUSTOMER PROFILE SUMMARIES VIA A DIGITAL ENGAGEMENT SERVICE

(71) Applicant: Twilio Inc., San Francisco, CA (US)

(72) Inventors: Athanasios Dimitrios Sotiriou, London (GB); Rakesh Bhatia, Irvine, CA (US); William Daniels, Broomfield, CO (US); Kevin King, Bargersville, IN (US); Aymen Naim, Walnut Creek, CA (US); Ruma Nair, San Francisco, CA (US); Kanish Manuja, Redmond, WA (US); Norman Shaukat, Sammamish, WA (US)

(21) Appl. No.: 18/441,838

(22) Filed: Feb. 14, 2024

Related U.S. Application Data
(60) Provisional application No. 63/534,049, filed on Aug. 22, 2023.

(51) Int. Cl. G06Q 30/015; G06F 40/20; G06F 40/40

(52) U.S. Cl. CPC G06Q 30/015; G06F 40/20; G06F 40/40

(57) ABSTRACT

A method for enhancing agent-customer interactions in a digital engagement service is provided. The method includes receiving a customer's communication request and initiating an asynchronous process to generate a customer profile summary using a customer identifier. This involves querying a customer data platform (CDP) for customer traits and event data, and creating a prompt for a large language model (LLM) to produce a concise customer profile summary. The summary, stored in a data store, is presented to an available agent through a user interface alongside an invitation to accept the incoming communication request. This streamlined approach equips agents with relevant customer insights promptly, improving service quality and response times.

### RELATED APPLICATIONS

This application claims the benefit of and priority to U.S. Provisional Patent Application No. 63/534,049, with title, “Techniques for Leveraging Generative Language Models in Integrating a Customer Data Platform with a Digital Engagement Service,” filed on Aug. 22, 2023, which is hereby incorporated by reference in its entirety for all purposes.

### TECHNICAL FIELD

The present application pertains to the technical field of cloud-based digital engagement platforms. More specifically, the innovations described herein relate to the application of artificial intelligence, including generative language models such as large language models (LLMs), to generate and provide real-time customer profile summaries. These customer profile summaries are presented in conjunction with invitations to accept incoming customer communication requests via a digital engagement platform, thereby preparing agents with contextual and actionable insights to enhance the customer service experience.

### BACKGROUND

A cloud-based customer data platform (“CDP”) is a software system that collects, organizes, and manages customer data from various sources and touchpoints. A CDP creates a unified and comprehensive customer profile that can be used by marketing, sales, and other teams for personalized communication and better decision-making. CDPs help companies improve customer experiences, target marketing campaigns, and gain insights into customer behavior and preferences.

A CDP works by collecting and integrating customer data from various sources, such as websites, mobile apps, email interactions, purchase history, social media, and more. The data is then cleansed, standardized, and transformed into a unified customer profile. This customer profile contains a holistic view of each customer, including their demographics, behaviors, preferences, interactions, and more. CDPs use advanced algorithms to analyze this data and to derive insights. These insights can be used to divide or group customers into different groups based on their characteristics and behaviors. This grouping of customers helps in creating targeted and personalized marketing campaigns, improving customer engagement, and tailoring interactions to specific customer needs.

CDPs also allow for the synchronization of data across various systems, enabling consistent and up-to-date customer information across different departments and touchpoints within a company. This helps in avoiding duplicate or contradictory data and ensures that everyone in the organization has access to the same accurate information. Overall, the goal of a CDP is to provide companies with a 360-degree view of their customers, enabling them to make informed decisions, enhance customer experiences, and drive business growth.

A cloud-based digital engagement service or platform is a platform or system that enables businesses to build and manage omnichannel customer communication and engagement solutions. A digital engagement service provides tools and capabilities to interact with customers across various digital channels, such as voice calls, video calls, messages (e.g., text, SMS, web chat, or proprietary), email, social media, and more. A modern cloud-based digital engagement platform allows businesses to create customized solutions tailored to their specific needs. Overall, digital engagement services empower businesses to provide efficient and personalized customer interactions across various digital channels, contributing to improved customer experiences and satisfaction.

### BRIEF DESCRIPTION OF THE DRAWINGS

Embodiments of the present invention are illustrated by way of example and not limitation in the figures of the accompanying drawings, in which:

FIG. 1 is a diagram illustrating a cloud-computing environment with several cloud-based services, including a digital engagement service, a customer data platform (“CDP”), and a language model service, all of which may be communicatively coupled with one another via a network and accessible via one or more application programming interface (“API”) specifications, consistent with some embodiments.

FIG. 2 is a diagram illustrating an example of a CDP, including a variety of data sources from which data may be obtained to create a customer profile, consistent with some embodiments.

FIG. 3 is a diagram illustrating an example of a digital engagement service, consistent with embodiments of the present invention.

FIG. 4 is a diagram illustrating an example of a customer interaction with an agent of a digital engagement service, where the customer interaction begins via a chat-bot and proceeds to a voice-based call, and is enhanced throughout with the timely presentation of insights gleaned from customer profile data and other data, consistent with some embodiments.

FIG. 5 is a diagram illustrating an example of a system architecture for integrating components of a digital engagement service with a customer data platform and a language model service, consistent with some examples.

FIG. 6 is a diagram illustrating a detailed view of the integration of the digital engagement service with a language model service, consistent with some embodiments.

FIG. 7 is a user interface diagram illustrating an example of an agent dashboard via which an invitation to accept an inbound communication request is presented along with a customer profile summary for the customer who has invoked the inbound communication request, consistent with some examples.

FIG. 8 is a flow diagram illustrating method operation performed as part of a computer-implemented method for generating and presenting a customer profile summary, consistent with some examples.

FIG. 9 is a user interface diagram illustrating an example of an agent dashboard via which a “next-best-action” recommendation is being presented to an agent, for discussing with the customer who has invoked the inbound communication request, consistent with some examples.

FIG. 10 is a flow diagram illustrating method operation performed as part of a computer-implemented method for generating and presenting a “next-best-action”, consistent with some examples.

FIG. 11 is a user interface diagram illustrating an example of an agent dashboard via which a post-communication “wrap-up” summary interface is being presented to an agent, consistent with some examples.

FIG. 12 is a flow diagram illustrating method operation performed as part of a computer-implemented method for generating and presenting a post-communication “wrap-up” summary interface, consistent with some examples.

FIG. 13 is diagrammatic representation of a computing device (e.g., a machine) within which instructions for causing the computing device to perform any one or more of the methodologies discussed herein may be stored and executed.

FIG. 14 is a block diagram illustrating a software architecture, which can be installed on any one or more of the devices described herein.

### DETAILED DESCRIPTION

Described herein are systems and methods for leveraging generative language models, for example, such as large language models (“LLMs”), in the integration of the functionality of a cloud-based digital engagement service with a cloud-based customer data platform (“CDP”). It will be evident to one skilled in the art, that the present invention may be practiced and/or implemented with varying combinations of the many details and features presented herein.

Integrating customer data from a CDP for use with a digital engagement service can be technically challenging due to the large volume and variety of customer profile data that is generated using a CDP. For instance, consider a CDP that is configured to aggregate extensive behavioral, transactional, and contextual data across a variety of different channels and systems into a unified customer profile. This customer profile may span long periods of time with data that is relevant to numerous touchpoints, interactions, and transactions. Moreover, the granularity of the customer profile data that is captured can be particularly fine—with event data, when considered alone, seemingly representing unimportant events, such as an interaction with a button of a mobile application. In contrast with other data sources, such as that available from customer relationship management (“CRM”) systems and publicly available social networking services, the volume and granularity of customer data generated by a CDP is unique. However, customer service representatives or agents need immediate access to the most relevant snippets of customer data during live engagements. Identifying appropriate real-time data from expansive CDP customer profiles is difficult, as it generally requires very fast intelligent filtering, grouping, and/or division. The customer profile data may be parsed, analyzed, and/or formatted for quick consumption, by customer service representatives or agents, in the digital engagement environment. Rapidly surfacing relevant insights from large datasets during live customer conversations may benefit from powerful integration technologies leveraging artificial intelligence (“AI”) and automation. Tight integration is also needed to update CDP customer profiles based on new interaction data. The scale and complexity of the customer profile data of a CDP makes integrating it with agent applications, in the context of a digital engagement service, technically difficult as compared to the more limited customer data that may be derived by a CRM system or obtained from a public profile hosted by a social networking service.

As described below, generative language models, including LLMs are leveraged to facilitate the integration of a cloud-based digital engagement service or platform with a CDP. Using the power of generative AI, vast amounts of customer profile data and other data can be efficiently analyzed, filtered, selected, summarized, and generally used in improving various functions of the digital engagement service. For example, in one aspect, a generative language model is used to create a contextually relevant customer profile summary of a customer's profile data, where the context used in generating the customer profile summary may include a real-time conversation transcript, the intent (e.g., objective) of the customer in initiating a communication session, or the sentiment of the customer as expressed during a communication session, along with the totality of a customer's profile data. The customer profile summary can be presented to the agent along with an invitation for the agent to accept an inbound communication request from the customer, thereby providing the agent with a better understanding of his or her customer and allowing the agent to provide better overall customer service. Similarly, a prompt provided as input to a generative language model may include a statement or instruction requesting the identification of some predetermined number of customer attributes or customer traits (e.g., as stored within the customer profile data of the customer), that are most relevant to the context (e.g., the conversation transcript, the customer intent and/or sentiment, and so forth).

In yet another example, a text-based conversation transcript, generated in near real-time, may be used as context with a prompt, provided as input to an LLM, for the purpose of identifying ideal or preferred agent characteristics or agent traits. For instance, given a conversation that may have occurred with an automated agent or chatbot, a user or customer may be routed to a human agent who is selected by identifying agent traits or characteristics that are best suited for the specific customer, the intent of the customer, the sentiment expressed or identified, etc., using a generative language model or LLM. Using the output of the model (e.g., the suggested agent characteristics and traits), an intelligent router of the digital engagement service can query various agent profiles to determine which of several available agents is to be selected to handle the customer communication, based on the agent profile including the desired agent characteristics or traits.

Building on the innovative use of generative language models (e.g., LLMs) in enhancing digital engagement services, another practical application involves the generation of prompts for LLMs that incorporate customer profile data and, optionally, a text-based transcript from an initial communication session. This initial communication session could have been managed by either an automated agent, such as a chatbot, or a human agent. The LLM prompt specifically instructs the LLM to analyze the provided context data to identify preferred traits or characteristics of an agent best suited to assist the customer further. This approach allows for a more personalized and efficient customer service experience by ensuring that the customer is matched with an agent whose skills, experience, and personal attributes align with the customer's needs and preferences. For example, if the text-based transcript indicates that the customer has technical issues with a product, the LLM might identify traits such as technical expertise in the product's category, patience, and clear communication as preferred traits for the agent. Consequently, the digital engagement service's intelligent router can then select an available agent who possesses these identified traits, thereby optimizing the likelihood of a successful and satisfying resolution for the customer.

In yet another example, during an on-going communication between a customer and agent, a prompt may be generated by the digital engagement service for use as an input to an LLM, where the prompt is formulated to include an instruction component and a context or data component. Here, the context may include customer profile data obtained from a CDP, including customer attributes or customer traits as well as customer event data, indicating various actions that have been undertaken by the customer. In some instances, additional customer data or company data may be obtained and added to the prompt as part of the context. This additional data may be from any of a large number of data sources, to include a knowledge base, a CRM system, or many others. The prompt instruction may direct or instruct the LLM to analyze the data provided as the context portion of the prompt, and direct the LLM to make a prediction about the customer's motivation for invoking the inbound communication request—a prediction or recommendation that may be referred to as the next-best action. For example, if the customer profile data, specifically the event data. reflects that the customer has recently made a purchase, and the event data also indicates an attempt by the customer to track the delivery of a package, resulting from the purchase, the next-best action, as predicted or determined by the LLM in analyzing the customer profile data may be to share with the customer the tracking information for the package. Accordingly, based on the output generated by the LLM, the digital engagement service may obtain and present insightful data to the agent, so that the agent can better serve the customer. For instance, in this example, the digital engagement service may update or refresh the user interface of the agent dashboard during the communication session with the customer to include information relating to the delivery and tracking of a package being sent to the customer. The information presented via the agent dashboard may be shared by the agent with the customer, for example, audibly during a voice or video call, but may also include an actionable link, or similar, that would allow the agent to send the information to the customer via one of several other communication channels, such as, email, mobile app notification, messaging application, and so forth.

In yet another example, the generative language model or LLM may be leveraged to assist the customer service representative or agent in performing various post-communication activities, such as generating a summary of the outcome of a communication or interaction with a customer. By way of example, upon the completion of a communication session with a customer, whether that session be a voice communication session, video communication session, or even a text-based messaging session, a text-based transcript of the communication session is generated, for example, using a speech-to-text algorithm in some instances. This text-based transcript is then provided as context in a prompt, submitted to an LLM as input. The instruction of the prompt may direct the LLM to analyze the text-based transcript and then generate various outputs. By way of example, one output may be a sentiment indicator or disposition code-for example, the customer was satisfied, or unsatisfied, neutral, happy, irritated, or an application or transaction was completed or requires follow-up, and so forth. In another example, the output may specify a topic to which the communication session was related, for example, technical help for a previously purchased product or service, assistance with completing a purchase transaction, and so forth. The instruction portion of the prompt may include or be associated with multi-shot examples, thereby constraining the output of the model to one of several predefined sentiment indicators, disposition statements, or topics. In another example, the instruction of the prompt may direct the LLM to analyze the transcript and generate a summary of the interaction between the agent and customer. In yet another example, the instruction of the LLM prompt may direct the LLM to analyze the context (e.g., the text-based transcript of the communication session) to generate a statement explaining the intent of the customer in invoking the communication session in the first place. By way of example, the statement of the customer's intent may be two to three sentences explaining the specific reason that the customer initiated the communication session with the agent. In yet another example, the instruction may direct the LLM to generate an overall summary description of the communication session, based on the text-based transcript.

These and other aspects of the various embodiments of the present invention are described in greater detail below, in connection with the detailed descriptions of the several figures that follows.

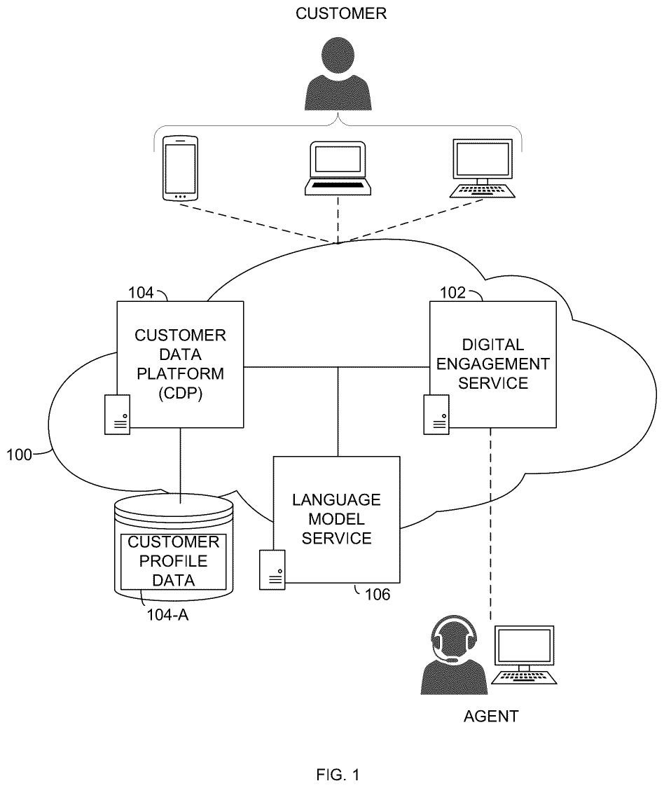

FIG. 1 is a diagram illustrating a cloud environment 100 with several cloud-based services, including a digital engagement service 102, a CDP 104, and a language model service 106. The three individual services may be communicatively coupled via a public network (e.g., the Internet) and one or more application programming interface (“API”) specifications, consistent with some embodiments.

The digital engagement service 102 provides capabilities to manage omnichannel customer interactions or communications across various digital channels like voice, video, chat, and messaging. In some examples, the components of the digital engagement service 102 may include an integrated voice response (“IVR”) unit, intelligent call routing, contact or customer management, and agent applications. Traditional digital engagement services, such as contact centers focus primarily on inbound calls for customer service and sales. However, modern digital engagement services, such as that shown in FIG. 1, now enable businesses to interact with a broader range of users, or customers, across multiple channels. Users may include customers, partners, employees, and other stakeholders. Support has also expanded beyond service and sales to include user onboarding, technical support, patient intake, student advising, and many, many more. These digital engagement services leverage technologies like cloud-based services, AI, and omnichannel interactions to streamline customer engagements or interactions across voice, video, chat, messaging, and other emerging channels. Given this evolution, the term “user” is often more fitting than the term “customer” when referring to the diverse people and needs supported by digital engagement services today. For purposes of the present application, the two terms should be considered to be analogous.

Building on the expansive capabilities of the digital engagement service 102, the concept of an “agent” plays a role in the orchestration of omnichannel customer interactions. An agent, within the context of this application and the invention as claimed, refers to a user of the digital engagement service who typically represents an enterprise or organization. Agents are the human interface between the technology and the users or customers seeking assistance, information, or engagement through the digital engagement service. Agents may be employed by or affiliated with an enterprise or organization utilizing the digital engagement service, serving in various capacities such as customer service representatives. technical support specialists, sales associates, or in other roles that necessitate direct interaction with customers or users across the digital channels supported by the service.

Agents may also include volunteers who contribute their time and expertise to support non-profit organizations, educational institutions, or community services through the digital engagement platform. This flexibility in the agent's role underscores the service's adaptability to a wide range of operational models, from commercial enterprises to volunteer-driven initiatives.

In some instances, an agent may not directly belong to any specific organization but may instead be an independent user of the digital engagement system. This scenario is particularly relevant in peer-to-peer support networks, freelance customer service ecosystems, or gig economy platforms where individuals offer their expertise or services directly to users or other businesses through the digital engagement service. Independent agents leverage the platform's capabilities to connect with clients, provide specialized services, and manage interactions efficiently, all while operating outside the traditional organizational employment model.

The versatility in the definition and role of an agent within the digital engagement service framework highlights the system's ability to cater to a diverse array of interaction needs. Whether representing a large corporation, a small business, a non-profit organization, or working independently, agents are integral to delivering the personalized, responsive service that customer or users expect across the omnichannel landscape facilitated by the digital engagement service.

The CDP 104 aggregates and stores unified customer profile data records (e.g., customer profile data 104-A) by ingesting data from data sources like websites, mobile apps, cloud services, CRM systems, and more. These consolidated customer profiles contain granular behavioral, transactional, and contextual data for each customer or user. In some examples, this data may be characterized as customer attribute or customer trait data, which typically involves data describing some characteristic of a customer, and customer event data, which generally tends to represent some behavior or activity undertaken by a customer. However, in various implementations, the specific characterization and categorization of the customer profile data may vary. The CDP 104 provides tools for companies and organizations to define customized data schemas and data elements specific to their business or organization. This enables capturing granular customer behaviors like email engagement events, button clicks in an app, product views on a website, and other detailed interactions. With customizable data capture, companies can model their CDP data schema to closely align with how they uniquely engage with customers across multiple and heterogenous touchpoints.

The language model service 106 provides pre-trained, generative AI models like LLMs and other tools to build and deploy custom trained and fine-tuned models. These models can power predictive analytics and personalization for the digital engagement service 102. In some instances, the language model service 106 may also improve model accuracy by continuously training on new data received from the digital engagement service 102 interactions. These models may power functionality facilitated by the digital engagement service 102, like generating customer profile summaries for presentation to an agent, generating next-best-action recommendations, generating post-communication customer summary records, and automated task triggering. In some examples, the language model service 106 may also continuously improve model accuracy and performance by ingesting new interaction data from the digital engagement service 102.

As illustrated in FIG. 1, in some examples, the services 102, 104, and 106 are hosted in the cloud environment 100 and integrated with one another via application programming interfaces (APIs). This enables real-time data sharing between the services to enhance both customer and agent interactions. However, it will be appreciated by those skilled in the art that various alternative deployments, including on premises hosting, and internal and open-sourced language models, may be used in various examples.

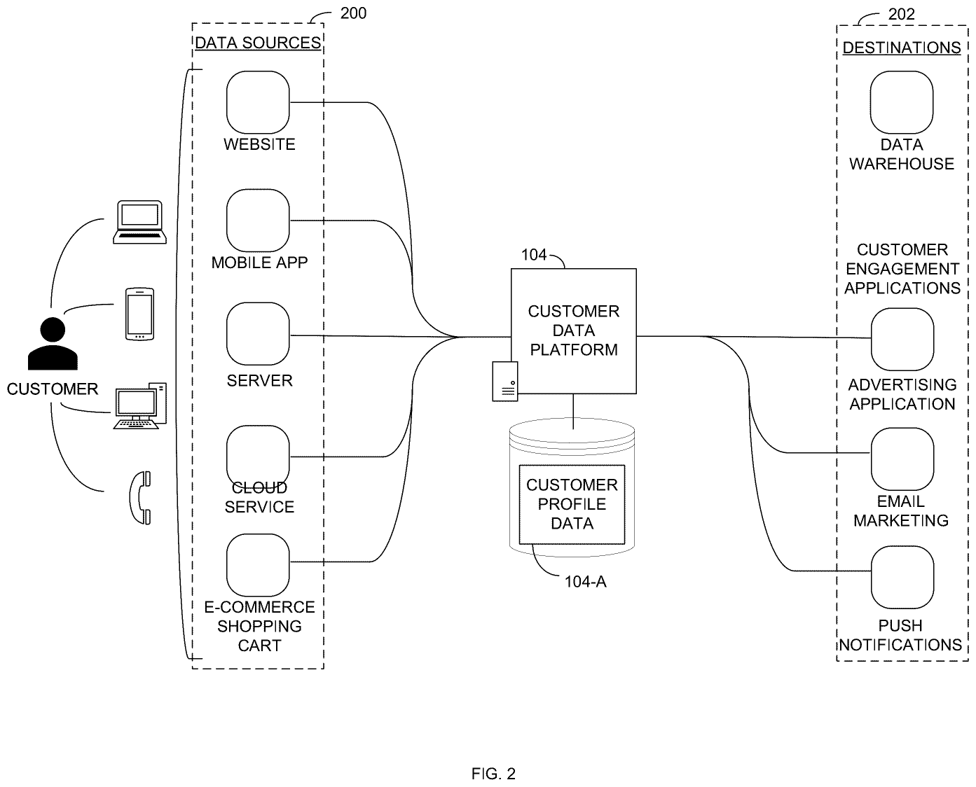

FIG. 2 is a diagram illustrating an example of a CDP 104, including a variety of data sources 200 from which customer data may be obtained to create a customer profile, consistent with some examples. The CDP consolidates customer data from a variety of data sources 200 into unified customer profiles 104-A, as shown in FIG. 2. The data sources 200 feeding into the CDP may be specified and customized by each company, and may include (but not be limited to):
Website interactions—data collected from customer activity on the company website, such as page views, searches, purchases, button clicks or selections, etc.
Mobile application interactions—data collected from customer use of mobile apps, such as app usage, in-app actions, transactions, etc.
Cloud service interactions—data from customer logins and usage of various cloud-based services offered by the company.
E-commerce shopping cart data—details on products viewed, added to cart and purchased from online shopping experiences.
Analytics data—insights derived from analysis of customer behaviors across platforms.
Other systems—Data from CRM systems, marketing automation systems, social networking services, etc.

The CDP 104 takes all this behavioral, transactional and interaction data from

the various data sources and aggregates it into unified customer profiles. The customer profiles can then be leveraged to power data destinations 202 like:
Data warehouse—for long term storage and analytics of the profile data, including machine learning applications.
Engagement applications—to enable personalized omnichannel customer experiences.
Advertising platforms—to target and personalize digital ads based on customer insights.
Email marketing—to divide and tailor email campaigns.
Marketing automation—to orchestrate contextual customer journeys.
Cloud services—to customize and configure SaaS applications per user.

The CDP 104 continuously ingests and aggregates customer data from the various data sources 200 in real-time. As new customer interactions occur, the relevant data is streamed into the CDP 104 via APIs and other integration technologies. The incoming raw customer data may include personal identifying data (e.g., customer identifiers) like email addresses, phone numbers, account usernames, and device IDs. An identity resolution system (not illustrated in FIG. 2) may process and analyze these customer identifiers to match and merge customer data associated with the same customers across different systems and touchpoints. This enables a holistic view of each customer by tying together multiple sequences of data into unified customer profiles.

Consistent with some examples, the identity resolution system utilizes probabilistic matching and pre-trained machine learning models to compare identifiers and calculate match confidence scores. Customizable business rules then determine which profiles to merge based on the match scores. As new data comes in, the identity resolution system continuously runs to “stitch” together more complete customer profiles. The processed customer data is persisted in a customer-centric data store optimized for low-latency reads and writes. The data schema is flexible and extendable to accommodate new data types from emerging sources. Customer profile data records are indexed for quick retrieval by customer identity, and in some cases, uniquely assigned system identifiers. The data store scales massively to support hundreds of millions of rich customer profiles. These persisted customer profiles contain granular customer attributes or customer traits and customer event data captured over time, such as contact details, transactions, web and app behaviors, service interactions, and more. This longitudinal view shows how customers engage across channels and reveals trends and patterns in their relationships.

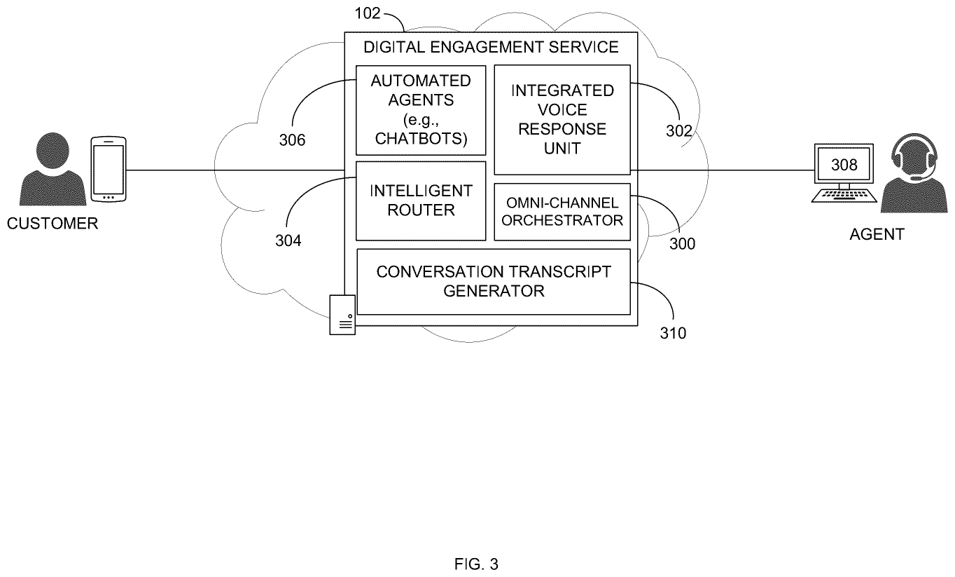

FIG. 3 is a diagram illustrating an example of a digital engagement service 102, consistent with embodiments of the present invention. The digital engagement service 102 provides an omnichannel orchestrator 300 to facilitate omnichannel customer interactions via voice, video, chat, messaging, and other communication channels. The engagement service 102 includes capabilities such as an integrated voice response unit 302, intelligent router 304, and automated agents (e.g., chatbots) 306, and agent applications (e.g., mobile or desktop-based) 308.

The digital engagement service 102 enables businesses to provide optimized customer experiences across multiple engagement or communication channels. The IVR unit 302 provides self-service capabilities for customers contacting via voice channels. It utilizes interactive voice menus and natural language processing to understand spoken requests and route communications appropriately. The intelligent router 304 uses capabilities like automatic call distribution (ACD) to route incoming customer interactions to appropriate agents or self-service channels based on business rules, channel capacity, agent skills/availability, and other factors.

Consistent with some examples, automated agents like virtual chatbots 306 can manage common customer inquiries via text-based messaging and web chats. These virtual agents 306 leverage natural language processing, machine learning, and in some instances, LLMs, to understand text-based requests and respond with relevant answers. Agent applications 308 provide the interfaces for human agents to manage customer interactions on desktop and mobile devices. These applications surface customer data and history to personalize engagements and may utilize AI-powered insights and recommendations.

Omnichannel orchestration coordinates and tracks customer journeys across multiple channels to enable seamless hand-offs. This provides a consistent experience as customers switch between self-service and agent-assisted channels. Overall, the digital engagement service 102 provides a customizable platform to streamline user support, sales, and service interactions across voice, video, digital messaging, email, and emerging engagement channels.

In some examples, the digital engagement service 102 includes a conversation transcript generator 310 that processes interactions between users or customers and agents, to create a chronological text-based transcript or record for each communication session. For example, for voice and video calls, the conversation transcript generator 310 uses automated speech recognition technologies like neural networks to analyze an audio conversation in real-time and transcribe spoken words into text. For text-based messaging, the generator 310 directly captures the typed conversation and structures it into a transcript document, annotated with relevant timestamps and source data. In both cases, the generator 310 compiles the sequential dialogue exchanges between the customer and agent into a cohesive text-based transcript file. This includes assigning timestamps and speaker labels to each text portion so that individual user utterances can be differentiated. Any accompanying metadata like timestamps is also embedded. The resulting structured transcript provides the full historical context of the conversation.

For live interactions like voice calls or video chats, the conversation transcript is generated continuously in real-time using automated speech recognition or text processing. As the customer and agent speak or exchange messages, the transcript generator 310 captures each new utterance or message and appends it to the existing transcript document. This updated transcript is then forwarded to downstream services at predefined intervals—for example, every 30 seconds. This results in the transcript being processed and analyzed in discrete chunks as the conversation progresses.

The language model service 106 is one of the downstream consumers of these real-time transcript updates. With each new chunk of transcript text, a prompt may be constructed using the latest conversation transcript as context and input to the LLM. The LLM then analyzes this prompt to generate a response based on the current state of the conversation. As the dialogue continues, additional transcript chunks are processed, allowing the LLM to adjust its responses accordingly. Updating the transcript and re-prompting the LLM periodically in this manner allows for dynamic, context-aware responses powered by the most recent conversational details. The system does not have to wait until the entire interaction is complete to begin processing it and reacting intelligently.

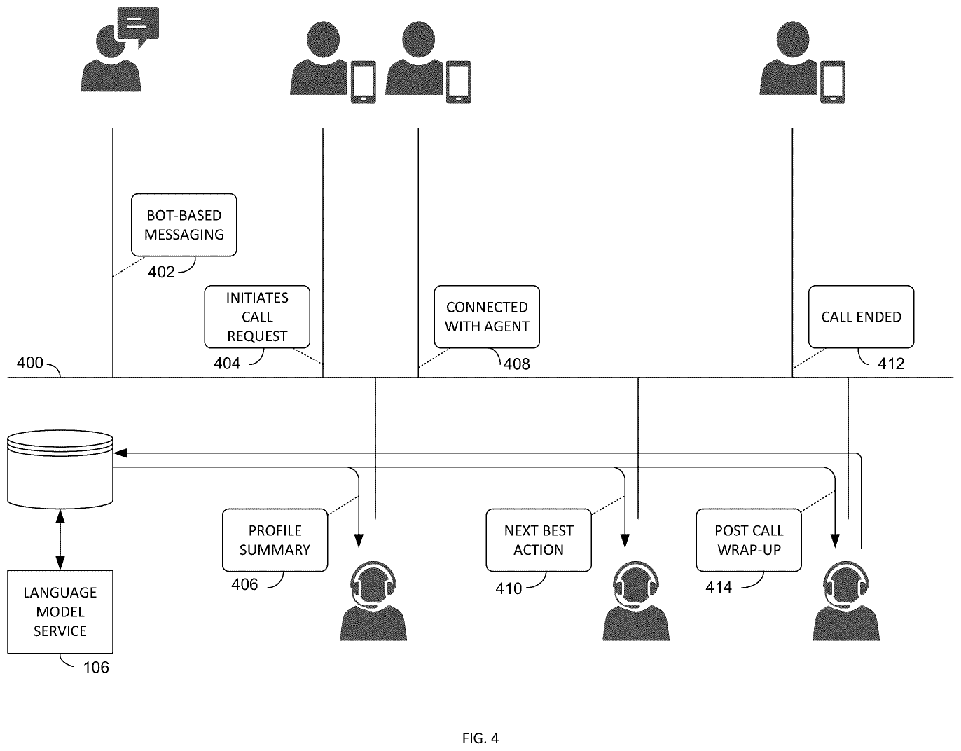

FIG. 4 is a diagram illustrating an example of a customer interaction with an agent of a digital engagement service, where the customer interaction begins via a chat-bot and proceeds to a voice-based call, and is enhanced throughout with the timely presentation of insights gleaned from customer profile data and other data, consistent with some embodiments. FIG. 4 illustrates a comprehensive overview of the utilization of an LLM within a digital engagement service to enhance a customer-agent interaction through the analysis and processing of data at various stages of communication. The depicted timeline 400 outlines a sequence of operations beginning with initial customer engagement and culminating in the post-communication analysis, showcasing how a generative language model, such as an LLM, can be leveraged to provide actionable insights and improve service quality.

The process initiates at operation 402, where a customer engages in a bot-based messaging session. This initial interaction may involve the customer seeking information. reporting an issue, or making a request through a chat interface powered by an automated system. The conversation with the bot is designed to gather preliminary data about the customer's needs and potentially resolve simple inquiries without human intervention.

Following the bot interaction, the customer may choose to escalate the communication by making an inbound communication request 404. This request signifies the customer's desire to speak directly with a human agent for further assistance. In response to this request, the system, at operation 406, dynamically generates a prompt that is submitted as input to an LLM service 106. The prompt includes instructions to analyze the customer's profile data (provided as context as part of the LLM prompt), along with any relevant context from the initial bot-based interaction, to generate a concise customer profile summary. This customer profile summary aims to equip the agent with a quick overview of the customer's background, preferences, and the nature of their inquiry or issue.

In some embodiments, the digital engagement service further refines the customer-agent interaction process through intelligent routing of customer requests, leveraging the insights provided by customer profile data, particularly event or interaction data. This advanced routing mechanism is facilitated by generating a prompt for the LLM, where the context for the prompt includes the customer's profile data, specifically, event or interaction data. This event data encapsulates the customer's activities and interactions prior to initiating the communication session, providing a detailed backdrop against which the LLM can operate. The LLM is then instructed to analyze this context data to recommend an optimal routing path for the customer's request, potentially specifying an agent or an agent type best suited to address the customer's current needs.

For instance, consider a scenario where a customer has been actively engaging with product tutorials and troubleshooting guides on a company's support website before reaching out for live assistance. By including this event data in the context of the LLM prompt, the system can intelligently deduce that the customer is likely seeking in-depth technical support. Consequently, the LLM may generate output recommending routing the customer's communication request directly to a specialized technical help queue, where agents with the requisite expertise are available to provide targeted assistance. Similarly, if event data indicates a customer's recent exploration of new product offerings or promotional deals, the LLM might generate output directing the customer to a sales assistant who can capitalize on the customer's purchasing intent.

This dynamic routing based on customer profile data, enriched with specific event or interaction insights, ensures that customers are connected with the most appropriate resources in a timely manner. It not only streamlines the customer service process, enhancing efficiency and satisfaction but also empowers agents by aligning their expertise with the needs of the customers they serve. By integrating such intelligent routing capabilities, the digital engagement service elevates the quality of customer interactions, fostering positive experiences and outcomes for both customers and agents.

Once the agent is connected with the customer at operation 408, the system generates another LLM prompt for submission as input to the LLM 106. This time, the prompt's instruction directs the LLM to identify a “next-best-action” recommendation 410 based on the ongoing conversation's context. The “next-best-action” could range from recommending a product, suggesting a solution to a problem, or advising on the next steps in a service process. This insight is then shared with or presented to the agent via a user interface associated with the agent dashboard, enabling the agent to discuss the recommendation with the customer, thereby ensuring a more informed and effective interaction.

Upon completion of the call, a third LLM prompt is generated for submission to the LLM at operation 414. This prompt includes the text-based transcript of the entire communication session between the customer and the agent. The instruction within the prompt asks the LLM to identify the sentiment of the caller, the caller's disposition or intent, a topic to which the communication relates, and to generate a summary of the conversation. This analysis provides a structured overview of the interaction's outcome, which the agent can review, modify, or edit before saving the information. This post-call wrap-up is important for documenting the interaction, deriving insights for future improvements, and ensuring that any follow-up actions are accurately captured and assigned.

By way of example, consider a scenario where a customer initiates a chat with a bot regarding a billing discrepancy. After a brief interaction 402, the customer requests to speak with a human agent 404. The system then generates a customer profile summary 406 highlighting the customer's account status, recent transactions, and previous complaints. When connected with the agent 408, the LLM output from the second prompt suggests the “next-best-action” recommendation 410, as reviewing the customer's last three transactions for errors. After resolving the issue, the post-call analysis 412 identifies the customer's satisfied sentiment and summarizes the resolution process for the agent's review.

This example exemplifies how integrating an LLM within a digital engagement service can significantly enhance the efficiency and effectiveness of a customer-agent interaction by providing real-time, data-driven insights throughout the communication process.

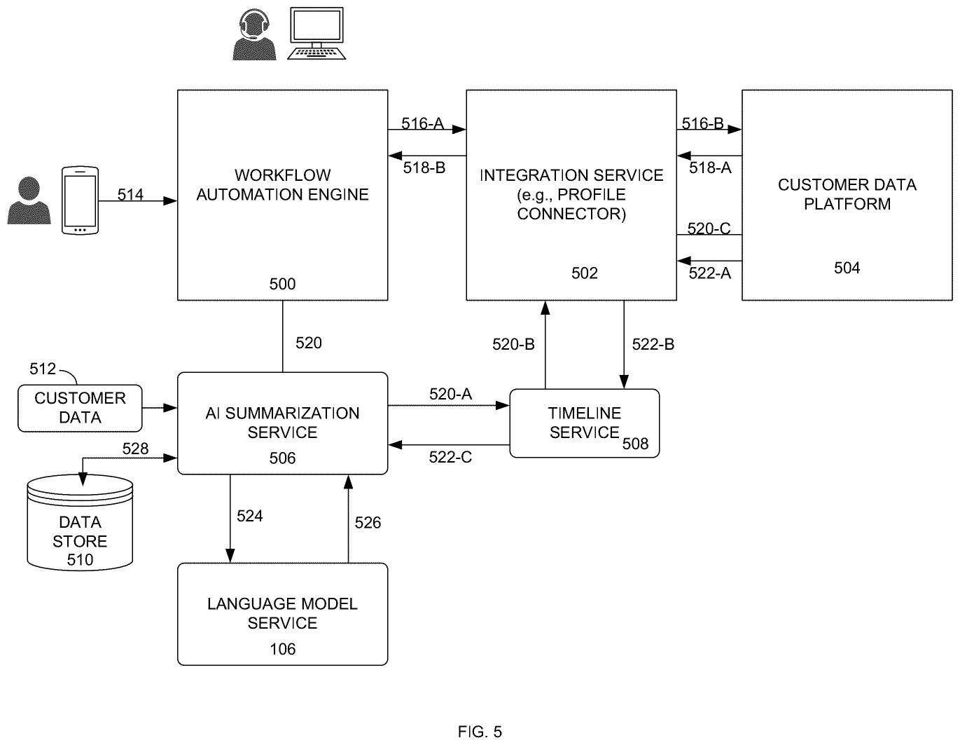

FIG. 5 is a diagram illustrating an example of a system architecture for integrating components of a digital engagement service with a customer data platform and a language model service, consistent with some examples. FIG. 5 presents a system architecture diagram that delineates the integration of a digital engagement service with a CDP and a language model service, specifically focusing on the utilization of one or more LLMs to enhance customer-agent interactions within a digital engagement environment. This architecture is designed to leverage customer data and AI-driven insights to streamline communication processes, improve customer service efficiency, and personalize customer interactions.

As illustrated in FIG. 5, the system architecture includes a workflow automation engine 500, which is a component of the digital engagement service. The workflow automation engine 500 is responsible for orchestrating the flow of data and commands across the system, ensuring seamless interaction between different components and services, particularly, during the processing of customer interactions.

The integration service 502, also known as the profile connector service, bridges the gap between the digital engagement service, specifically the workflow automation engine 500, and the CDP 504. The integration service 50 aids in the seamless retrieval of comprehensive customer profile data from the CDP, leveraging unique identifiers such as customer IDs. These customer identifiers are used for fetching a wide array of customer-related information, including but not limited to customer attributes, historical interactions, preferences, and other significant data stored within the CDP.

Upon the receipt of an incoming communication request, this request inherently includes customer ID information, which serves as a key to accessing the customer data stored in the CDP. The integration service 502 then the task of mapping this customer ID information to a unique system-generated ID, a process that ensures a robust and reliable linkage between the customer's various identifiers and their comprehensive profile data. This unique system-generated ID is designed to transcend the limitations of using a single customer ID, enabling the identification and aggregation of customer profile data that may be mapped to multiple customer IDs associated with the same individual. This could include identifiers used across different channels or platforms, such as email addresses, phone numbers, or social media handles, thereby providing a holistic view of the customer's interactions and preferences.

For instance, when a customer initiates a communication session using their phone number, the integration service 502 maps this phone number to the customer's unique system-generated ID. This ID then serves as a master key, unlocking all relevant customer profile data associated with the customer, regardless of the specific identifier used in past interactions. This could reveal a rich history of interactions, preferences, and behaviors that are crucial for personalizing the customer's experience during the current communication session. By leveraging this comprehensive view, agents are better equipped to understand the customer's needs, anticipate their inquiries, and deliver tailored, efficient service that enhances customer satisfaction and loyalty.

The Al summarization service 506 is a component that interfaces with the language model service 106. The AI summarization service 506 dynamically generates LLM prompts based on customer interactions and profile data, which are then submitted to the LLM for processing. These prompts are formulated to instruct the LLM to perform specific tasks, such as generating customer profile summaries, identifying next-best actions, or analyzing conversation transcripts for sentiment, topics, and key themes.

Consistent with some examples, the timeline service 508 plays a role in managing and organizing customer event data, specifically. For example, the timeline service 508 collects data on customer interactions across various channels and touchpoints, providing a chronological view of a customer's journey, which may be presented via a user interface of the agent's dashboard during a communication session. Moreover, the timeline service 508 ensures that the most relevant and recent customer interactions (event data) are considered when generating LLM prompts for the LLM.

Consistent with some examples, the language model service 106 is an external service that hosts one or more LLMs. It receives prompts from the AI summarization service 506, processes these prompts according to the instructions contained within, and returns the generated outputs back to the AI summarization service 506. These outputs can include customer profile summaries, recommended actions, sentiment analyses, and conversation summaries, which are then utilized to enhance customer-agent interactions.

In operation, when a customer or user initiates a communication request 514 through the digital engagement service, the workflow automation engine 500 triggers (e.g., 516-A and 516-B) the integration service 502 to fetch (e.g., 518-A and 518-B) relevant customer data from the CDP 504. Simultaneously, event data related to the customer's current and past interactions is retrieved via the timeline service 508, as shown with reference 520-A, 520-B, 520-C, and returned (522-A, 522-B and 522-C). This data is processed and compiled at the AI summarization service 506 to formulate a prompt, including at least an instruction and context data, for the LLM 106. The prompt is provided as input 524 to the LLM service 106, which then returns an output 526. The output from the LLM, processed by the Language Model Service 106, is then stored 528 in the data store 510 and made available to the digital engagement service to inform the ongoing customer interaction. Accordingly, when the incoming communication request from the user is matched with an available agent, the user interface of the available agent is updated to present the customer profile summary, as obtained from the data store 510, along with an invitation to accept the incoming communication request from the customer or user.

This architecture, as illustrated in FIG. 5, exemplifies the integration of a customer data platform, AI-driven language model, and digital engagement service to create a responsive, data-informed customer service environment. By leveraging real-time data and AI insights, the system ensures that customer interactions are personalized, efficient, and informed by the latest customer data and analytics.

In addition to generating customer profile summaries, this integrated system architecture also facilitates the generation of next-best-action recommendations, a feature that further personalizes and enhances the customer service experience. In these instances, customer data 512, which may be obtained from a variety of sources, is utilized as context data in formulating prompts for the LLM 106. This process involves not only the data retrieved from the CDP 504 and the event data from the timeline service 508 but also potentially incorporates additional data sources that provide a more comprehensive view of the customer's interactions, preferences, and needs.

For example, customer data 512 used in generating next-best-action recommendations could include information from an order tracking system, information from a company knowledge base, a product catalog, or information from a wide variety of other data sources. In certain scenarios, this data allows the AI summarization service 506 to construct detailed prompts that instruct the LLM 106 to analyze the customer's current situation, past behaviors, and potential future needs. The LLM, leveraging its vast knowledge base and understanding of customer service dynamics, processes these prompts and generates actionable recommendations that agents can use to guide the conversation towards satisfying resolutions.

Consider a scenario where a customer has been browsing various product pages on an e-commerce site without making a purchase. The digital engagement service, upon receiving a communication request from this customer, could leverage browsing history, combined with previous purchase data and any available customer feedback, to generate a prompt for the LLM. The LLM, in turn, might recommend the agent to highlight a current promotion on products the customer viewed or suggest offering personalized assistance in selecting a product that meets the customer's needs. This next-best-action recommendation not only addresses the customer's immediate context but also anticipates their needs, thereby creating a more engaging and satisfying customer service interaction. Through such dynamic use of customer data and AI insights, the system ensures that every customer interaction is as informative, efficient, and personalized as possible, significantly enhancing the overall customer experience.

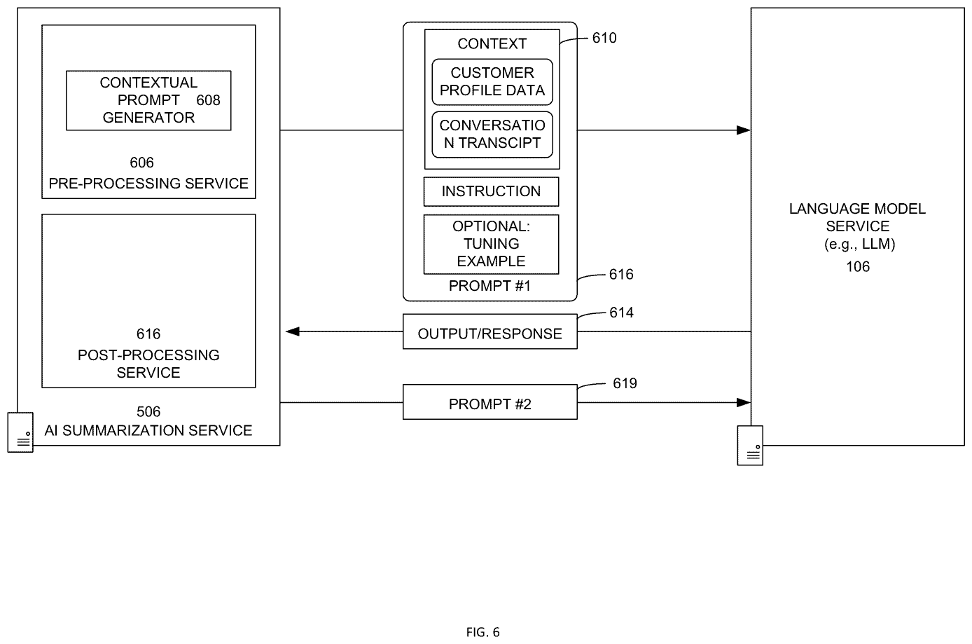

FIG. 6 illustrates a detailed view of the integration between a digital engagement service and a language model service, emphasizing the role of an LLM in processing and analyzing data to enhance customer-agent interactions. As illustrated in FIG. 6, the emphasis is on the operational flow involving the generation of prompts for the LLM and the subsequent utilization of the LLM's outputs to inform and improve interactions within a digital engagement platform.

As shown in FIG. 6, the AI summarization service 506 acts as the intermediary between the digital engagement service and the language model service 106. The AI summarization service 506 is tasked with constructing and managing the prompts that are submitted to the LLM for processing. These prompts are formulated based on a combination of real-time interaction or event data, customer profile data, and, potentially, additional context from previous interactions or external data sources.

The process begins with the pre-processing service 606, which receives raw data inputs, including customer profile data and conversation transcripts. This service is responsible for preparing the data to be included in the prompts for the LLM. It may involve filtering, summarizing, or augmenting the data to ensure that the prompts are optimally structured for processing by the LLM. The pre-processing service 606 ensures that the context data is relevant, concise, and formatted in a manner that maximizes the efficacy of the LLM's analysis.

The contextual prompt generator 608 is a component within the AI summarization service 506. It takes the pre-processed data and constructs prompts that include, in some instances, both an instruction component and a context data component. The instruction component directs the LLM on the specific task to be performed, such as generating a customer profile summary, identifying next-best actions, or analyzing sentiment. The context data component provides the necessary background information, derived from the customer's profile and interaction history, to inform the LLM's analysis.

Additionally, with some embodiments, the LLM may be furnished with an understanding of the business goals to further refine its analysis and recommendations. This strategic input allows the LLM to align its output with the overarching objectives of the enterprise or organization utilizing the digital engagement service. By incorporating the business goals into the context of the prompts, the LLM is empowered to not only consider the immediate needs and history of the customer but also to weigh these against the business's priorities and targets. This approach ensures that the output indicating the actions recommended by the LLM, whether they pertain to customer service resolutions, sales opportunities, or other interactions, are not only tailored to the customer's specific situation but also contribute positively to the achievement of the business's goals. For instance, if increasing customer retention is a key objective, the LLM might prioritize actions that enhance customer satisfaction and loyalty in its recommendations. This integration of business goals into the LLM's operational framework enhances the relevance and impact of its insights, ensuring that the digital engagement service not only meets the immediate needs of customers but also advances the strategic interests of the business.

Once the prompts are generated, they are submitted to the language model service 106, which hosts the LLM. The LLM processes the prompts according to the specified instructions, leveraging its vast knowledge base and linguistic capabilities to generate insightful outputs. These outputs may include synthesized customer profile summaries, recommended actions for the agent to take, sentiment analyses of the conversation, or other relevant insights that can enhance the customer service experience.

The post-processing service 616 receives the outputs from the LLM and performs additional refinement and formatting. This may involve extracting key information, summarizing lengthy outputs, validating outputs to ensure compliance with business rules, or translating the LLM's analysis into actionable insights for the agent. The post-processed outputs are then made available to the digital engagement service, where they can be presented to the agent through the user interface of the agent dashboard.

In operation. FIG. 6 depicts a workflow that leverages advanced AI capabilities to analyze customer data and interaction transcripts, generating actionable insights that can significantly enhance the quality and efficiency of customer-agent interactions. By integrating the LLM's analytical abilities with the digital engagement service, the system ensures that agents are equipped with the most relevant and up-to-date information, enabling them to provide personalized, informed, and effective customer service.

In the detailed architecture of FIG. 6, the contextual prompt generator 608 within the AI summarization service 506 exhibits the capability to generate prompts tailored to the specific requirements of various tasks. The nature of the task at hand—be it generating customer profile summaries, identifying next-best actions, or conducting sentiment analysis—dictates the formulation of the prompt. This customization ensures that the prompts are optimally structured to elicit the most relevant and accurate outputs from the LLM. Furthermore, recognizing the diversity in the capabilities and specializations of different LLMs, the AI summarization service 506 may, in some examples, be equipped with the functionality to route prompts to a specific LLM that is best suited for the task specified in the prompt. This routing mechanism allows for the utilization of multiple LLMs within the Language Model Service 106, each potentially fine-tuned for particular types of analysis or possessing unique knowledge bases. Consequently, a prompt intended for sentiment analysis might be directed to an LLM specialized in understanding emotional nuances in text, while a prompt for generating a customer profile summary might be routed to an LLM that excels in synthesizing comprehensive overviews from detailed data. This strategic routing and task-specific prompt generation significantly enhance the efficiency and effectiveness of the LLM's contributions to improving customer-agent interactions within the digital engagement platform. In some examples, multiple language model services may be utilized for diversification, and back-up and redundancy purposes.

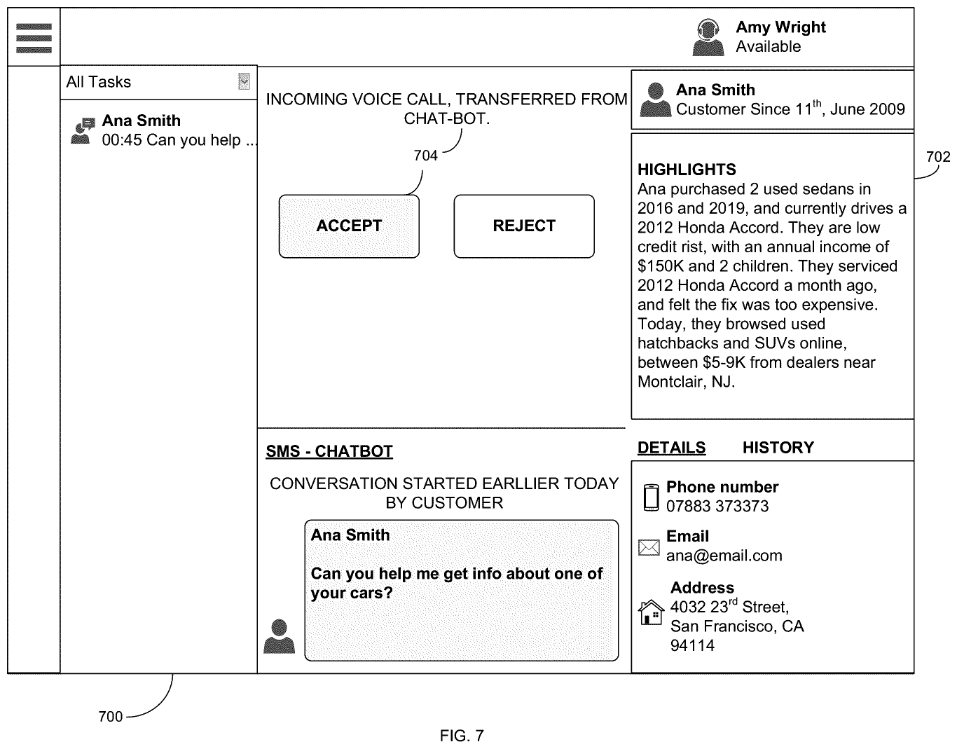

FIG. 7 is a user interface diagram illustrating an example of an agent dashboard 700 via which an invitation to accept 704 an inbound communication request is presented along with a customer profile summary 702 for the customer who has invoked the inbound communication request, consistent with some examples. FIG. 7 showcases a user interface (UI) design for an agent dashboard within a digital engagement service platform. This UI is designed to empower agents with customer insights and actionable data at the moment of engagement, thereby significantly enhancing the customer service experience. The interface 700 is divided into several sections, each designed to present information in an intuitive and accessible manner.

In the upper right section of the UI is the “Highlights” section, which provides a concise customer profile summary 702. This summary 702 is strategically positioned to catch the agent's attention immediately upon receiving an incoming communication request from a customer. The “Highlights” section 702 distills essential customer information, including purchase history, account status, recent interactions, and any notable preferences or issues previously expressed by the customer. For example, it might indicate that the customer, “Ana Smith.” has been a customer since Jun. 11, 2009, has purchased two used sedans in 2016 and 2019, and recently expressed concerns over the cost of a service for their 2012 Honda Accord. Additionally, it may note that the customer browsed used hatchbacks and SUVs online, indicating a potential interest in making another purchase.

Consistent with some embodiments, the LLM prompt used to generate the customer profile summary may include in the instruction portion an indicator of the maximum length of the summary to be generated by the LLM, which may be specified in terms of a number of words, characters, or sentences, and is generally selected to ensure that the customer profile summary generated by the LLM is concise and readily consumable by the agent when the invitation is being presented. In the context of the application, the terms “concise” and “readily consumable” refer to the presentation of the customer profile summary in a manner that is both succinct and easily understood by the agent at a glance. Specifically, “concise” implies that the summary is stripped of any superfluous information or extraneous details that do not directly contribute to the agent's understanding of the customer's immediate needs, background, or the context of their inquiry. This means that the summary is distilled down to the most pertinent pieces of information, such as key customer behaviors, recent interactions, and relevant preferences, presented in a clear and straightforward manner.

“Readily consumable,” on the other hand, emphasizes the ease with which an agent can quickly grasp the essential insights from the summary without the need for extensive reading or interpretation. This is achieved by organizing the summary in a logical, structured format that highlights critical information at the forefront, possibly through the use of bullet points, short sentences, or highlighted keywords. The goal is to enable the agent to absorb the necessary information within a brief glance or a few seconds, thereby minimizing any delay in responding to the customer and enhancing the efficiency of the interaction.

Together, these qualities ensure that the customer profile summary serves as an effective tool for agents, enabling them to immediately understand the customer's context and tailor their approach accordingly, without being bogged down by unnecessary details or complex interpretations. This approach not only streamlines the communication process but also contributes to a more personalized and responsive customer service experience.

Adjacent to the “Highlights” section, the UI prominently features an invitation to accept the incoming communication request. This invitation is displayed in a manner that ensures the agent can easily see both the invitation and the customer profile summary simultaneously, without needing to navigate away from the current screen. The invitation includes basic details about the nature of the request (e.g., voice call, video call, or messaging session) and the customer's name, providing a clear context for the interaction.

The design of the UI allows the agent to quickly form an understanding of the customer's query or potential needs before even accepting the incoming request. This pre-emptive insight enables the agent to tailor their approach to the interaction, anticipate possible solutions, and prepare relevant information or resources. By integrating the customer profile summary directly into the agent dashboard in this manner, the digital engagement service facilitates a more informed, efficient, and personalized customer service experience.

Furthermore, the UI 700 includes interactive elements that allow the agent to accept, reject, or defer the incoming request, providing flexibility in how they manage their workflow and prioritize customer interactions. Additional features, such as access to detailed customer history, account information, and previous interaction transcripts, are also accessible from the dashboard, ensuring that agents have all the necessary tools and information at their fingertips to deliver exceptional service.

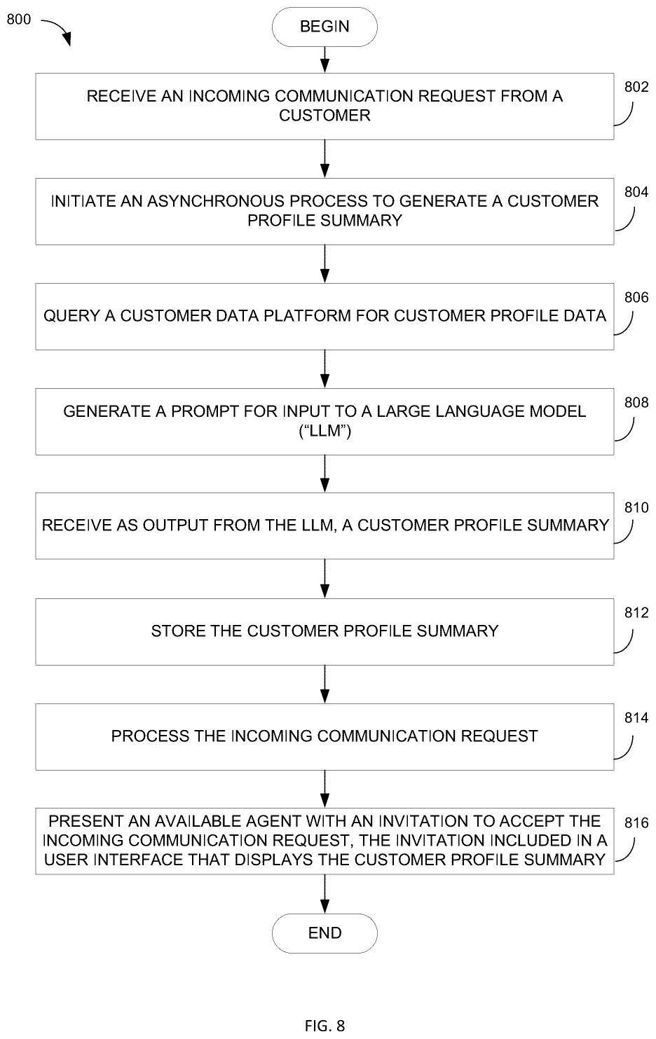

FIG. 8 illustrates a flow diagram detailing the steps involved in generating and presenting a customer profile summary alongside an invitation to accept an incoming communication request within a digital engagement service platform. As such, FIG. 8 encapsulates the seamless integration of AI-driven insights with the operational workflow of customer service agents, enhancing the efficiency and effectiveness of customer interactions.

The process initiates when an incoming communication request from a customer is received 802. triggering an asynchronous process designed to enrich the agent's understanding of the customer without delaying the service workflow 804. The system queries the CDP for detailed customer profile data using the customer identifier provided with the request 806, ensuring that all relevant customer information is considered in generating the profile summary.

A prompt, specifically tailored to instruct the LLM to synthesize a concise summary from the customer profile data, is generated and submitted to the LLM 808. The LLM's output, a customer profile summary, is then received 810 and stored for quick access 812.

As the incoming communication request is processed and assigned to an available agent 814, the agent dashboard is dynamically updated to present the customer profile summary alongside the invitation to accept the communication request 816. This integration ensures that agents are equipped with actionable insights derived from the customer's profile, enabling them to tailor their approach to the interaction and provide personalized, informed customer service.

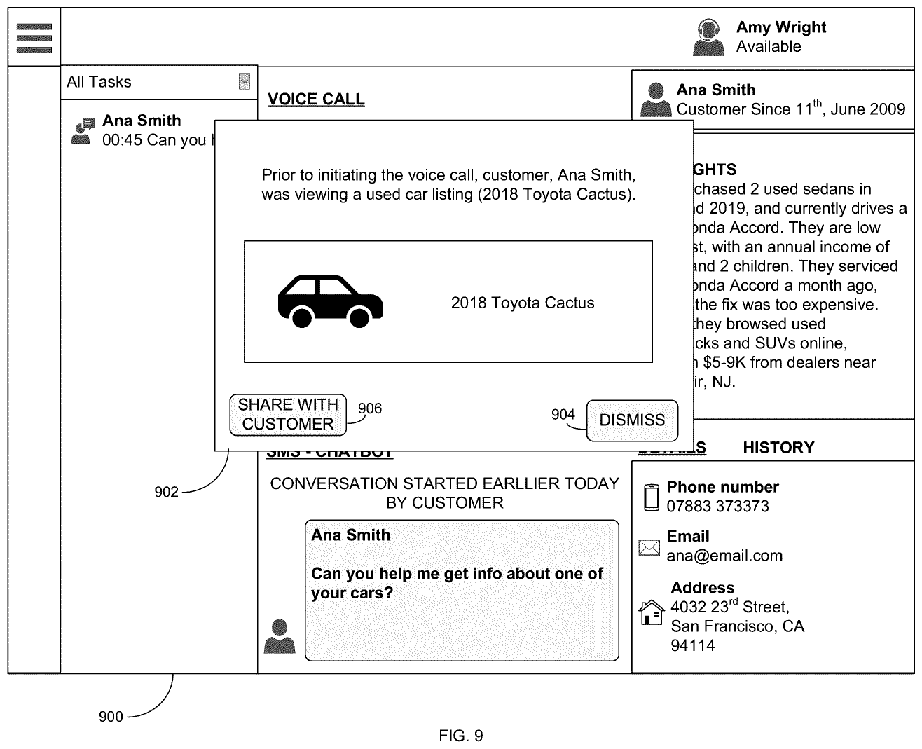

FIG. 9 is a user interface diagram illustrating an example of an agent dashboard 900 via which a “next-best-action” recommendation 902 is being presented to an agent, for discussing with the customer who has invoked the inbound communication request, consistent with some examples. FIG. 9 illustrates a user interface (UI) design for an agent dashboard 900 within a digital engagement service platform, specifically focusing on a pop-up window or interface 902 that presents a “next-best-action” recommendation to the agent. This feature is designed to augment the agent's decision-making process by providing AI-driven insights based on the analysis of customer data and interaction history. The UI is designed to seamlessly integrate these recommendations into the agent's workflow, thereby enhancing the efficiency and effectiveness of customer service. Although shown in FIG. 9 as a pop-up window or interface, in various alternative examples, the recommendation 902 may be presented in different formats using different visual interface techniques.

The pop-up window 902 is strategically designed to capture the agent's attention without disrupting their workflow. It appears in the context of an ongoing customer interaction, such as a voice call or chat session, where the agent is already engaged in addressing the customer's needs. The window prominently displays the “next-best-action” recommendation 902, which is generated based on a comprehensive analysis of the customer's profile, recent activities, and the current conversation's context. For example, the recommendation might suggest sharing information about a used car listing (e.g., a 2018 Toyota Cactus) that the customer viewed prior to initiating the call, indicating a potential interest in purchasing the vehicle.

The UI provides two primary options for the agent to act on the recommendation: “Share with Customer” 906 and “Dismiss” 904. The “Share with Customer” option 906 allows the agent to directly communicate the recommended action or information to the customer, potentially facilitating the customer's decision-making process or addressing their inquiry more effectively. This option is designed to be easily actionable, enabling the agent to convey the information with minimal effort and without leaving the current interface. The sharing of the information may be through any of a number of available channels, including messaging, a mobile app, and/or email.

The “Dismiss” option 904 gives the agent the flexibility to disregard the recommendation if they deem it irrelevant or not useful in the context of the current interaction. This feature acknowledges the agent's expertise and judgment in managing customer interactions, allowing them to maintain control over the conversation's flow and content.

Accordingly, FIG. 9 depicts a user interface for an agent dashboard that thoughtfully integrates AI-generated “next-best-action” recommendations into the customer service process. By presenting these recommendations in a non-intrusive, easily actionable manner, the digital engagement service empowers agents to deliver personalized, data-driven customer service, ultimately enhancing the customer experience and potentially driving positive outcomes for the business.

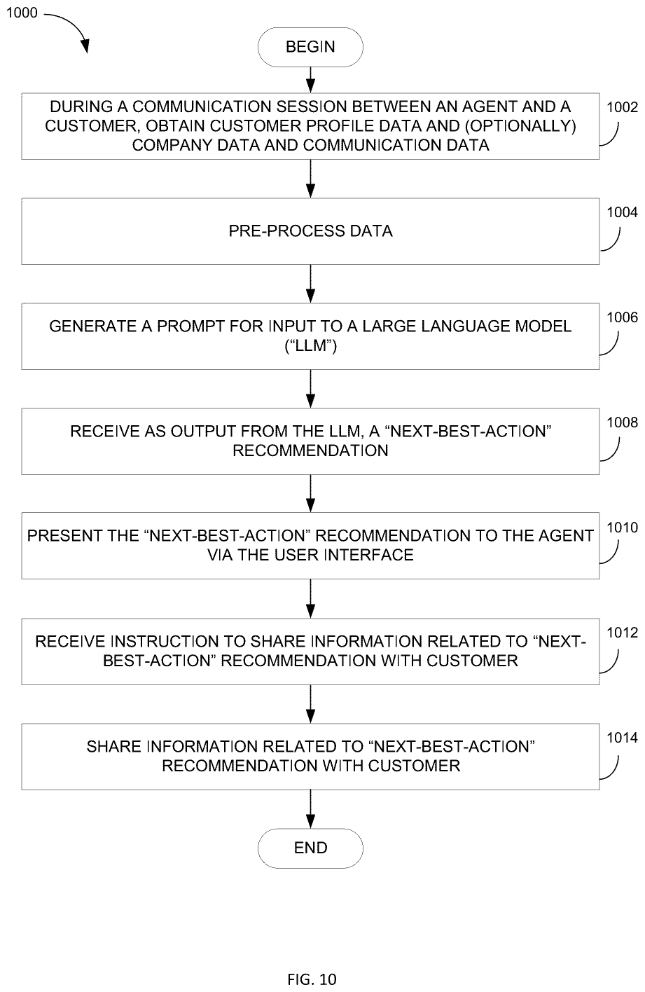

FIG. 10 illustrates a flow diagram detailing the process involved in generating and presenting a “next-best-action” recommendation during an ongoing communication session with a customer within a digital engagement service platform. This diagram encapsulates the integration of real-time data analysis and AI-driven insights to support agents in delivering personalized and effective customer service.

The method begins with the start of a communication session between a customer and an agent 1002, during which customer profile data—including event or interaction data—is collected and pre-processed in real-time 1004. This data includes not only the textual or verbal exchange between the customer and the agent but also any relevant customer actions, inquiries, or expressed needs. Consistent with some examples, the pre-processing of the data 1004 is governed by a set of predefined business rules and algorithms designed to distill the most relevant and actionable insights from the raw data. For instance, the business rules may prioritize recent interactions over older ones, highlight patterns of customer behavior that indicate a higher likelihood of purchase, or filter out redundant information to focus on data points that significantly impact customer satisfaction and service efficiency. Additionally, the pre-processing may involve categorizing the data into various segments such as inquiries, complaints, or feedback, making it easier for the AI summarization service to generate precise and contextually relevant prompts for the LLM. This careful orchestration ensures that the data fed into the LLM is not only clean and structured but also aligned with the strategic objectives of the digital engagement service, thereby enhancing the effectiveness of the “next-best-action” recommendations.

At operation 1006, utilizing the pre-processed data, a detailed prompt is generated for input to an LLM. This prompt includes specific instructions for the LLM to analyze the provided context data and identify a “next-best-action” recommendation based on the customer's current situation and historical interactions.

At operation 1008, upon receiving the prompt, the LLM processes the information, leveraging its extensive knowledge base and AI capabilities to generate a “next-best-action” recommendation. This step leverages the abilities of generative AI to derive actionable insights that can guide the agent's next steps in the communication session.

The recommendation generated by the LLM is then presented to the agent through the user interface of the digital engagement service platform, at operation 1010. This user interface is designed to display the recommendation in an intuitive and easily accessible manner, ensuring that the agent can quickly assess its relevance and potential impact on the ongoing interaction.

With the recommendation at their disposal, the agent makes an informed decision on how to proceed at operation 1012. The agent may choose to share the recommended action with the customer, thereby enhancing the interaction with personalized and proactive service. Alternatively, the agent may decide to modify or dismiss the recommendation based on their judgment and understanding of the customer's needs. At operation 1014, if the agent opts to share the recommendation, this step involves communicating the suggested action or information to the customer. This could involve discussing product options, offering solutions, or providing guidance that aligns with the customer's inquiries and preferences. The recommendation, as presented to the agent, will have a link or some other user interface mechanism by which the agent can quickly and easily convey information to the user, via one of several communication channels, such as messaging, email, mobile application, and so forth.

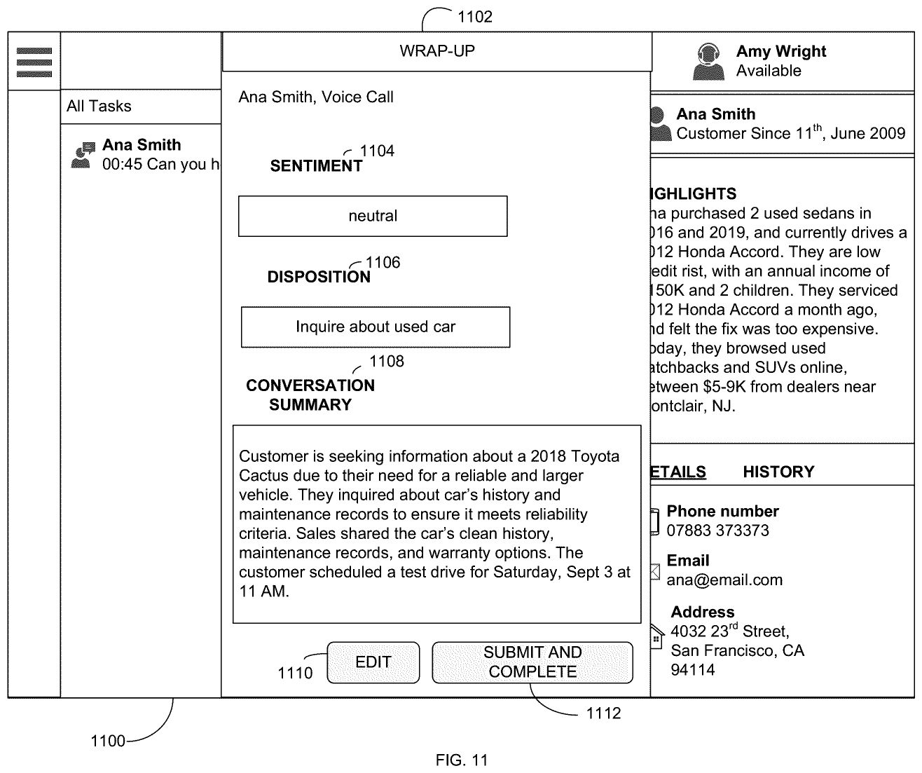

FIG. 11 is a user interface diagram illustrating an example of an agent dashboard 1100 via which a post-communication “wrap-up” summary interface 1102 is being presented to an agent, consistent with some examples. This user interface is designed to streamline the process of summarizing and documenting the outcomes of customer interactions, leveraging the analytical capabilities of an LLM to generate key data elements from the text-based transcript of the communication. The UI is designed to ensure that agents can efficiently review, modify, and confirm the details of the interaction, thereby enhancing the accuracy and utility of the customer profile data.

As shown in FIG. 11 with reference 1102 is the “wrap-up” section, which is prominently displayed to the agent following the conclusion of a customer interaction, such as a voice call or chat session. This section is divided into several areas, each designed to present specific insights generated by the LLM based on its analysis of the conversation transcript.

The first area displays the “Sentiment” 1104 identified during the interaction, providing the agent with an AI-generated assessment of the customer's emotional tone throughout the communication. For example, the sentiment might be labeled as “neutral,” indicating that the customer's emotional state was neither particularly positive nor negative. This sentiment analysis offers valuable context for understanding the customer's experience and can inform future interactions.

Next, the “Disposition” 1106 or caller intent is presented, summarizing the primary reason or objective behind the customer's communication request. This concise statement, such as “Inquire about used car,” distills the essence of the interaction, enabling agents and other team members to quickly grasp the customer's needs or concerns.

The “Conversation Summary” 1108 section provides a more detailed overview of the interaction, highlighting key points, customer inquiries, and any resolutions or recommendations provided by the agent. This summary is generated by the LLM to capture the interaction's substance, ensuring that critical information is documented and accessible for future reference.

The UI empowers agents with the ability to “Edit” 1110 any of the presented data elements before they are officially saved to the customer's profile. Editable fields allow agents to refine the AI-generated content, ensuring that the final documentation accurately reflects the interaction's nuances and outcomes. This editing capability respects the agent's expertise and firsthand knowledge of the interaction, allowing for corrections or additions that enhance the quality of the customer profile data.

Finally, the UI includes an action button labeled “Submit and Complete,” 1112 which the agent selects to finalize the wrap-up process. Upon submission, the edited sentiment analysis, disposition, and conversation summary are integrated into the customer's official profile, enriching the customer data with valuable insights from the interaction.

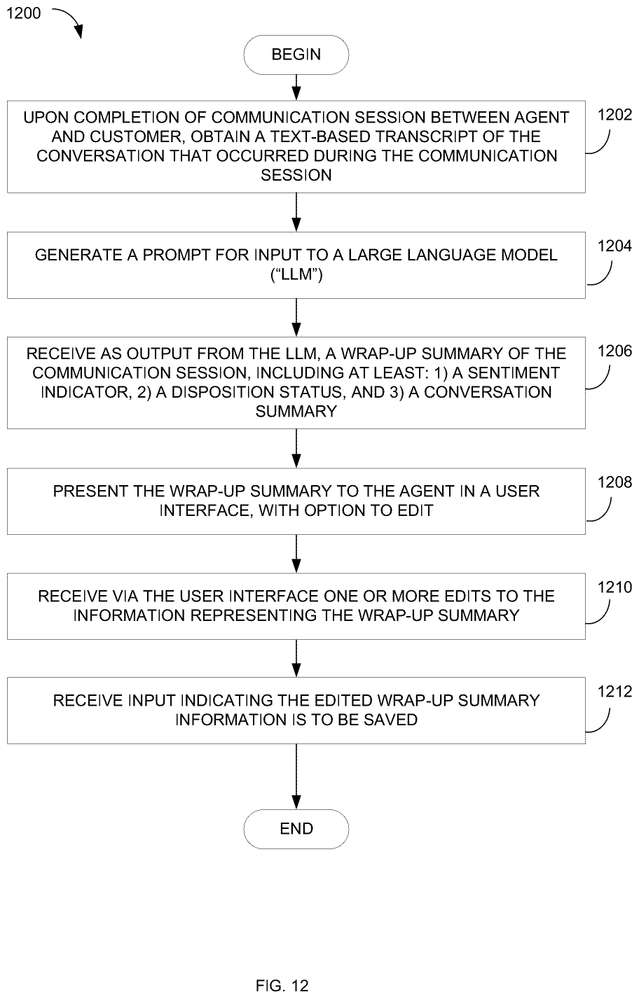

FIG. 12 is a flow diagram that outlines a computer-implemented method for generating and presenting a post-communication “wrap-up” summary interface to an agent within a digital engagement service platform. This method is designed to streamline the process of summarizing the outcomes of customer interactions, leveraging the analytical capabilities of an LLM to extract key insights from the text-based transcript of the communication session. The method ensures that agents can efficiently review, modify, and confirm the details of the interaction, thereby enhancing the accuracy and utility of the customer profile data.

At method operation 1200, the method initiates upon the completion of a communication session between an agent and a customer. This step marks the end of the direct interaction, setting the stage for the generation of a comprehensive summary that encapsulates the essence of the conversation that occurred during the communication session.

At method operation 1202, following the conclusion of the communication session, an LLM prompt is generated for input to the LLM. This prompt is formulated to include both an instruction component and a context data component, where the context data comprises the text-based transcript of the entire communication session. The instruction is specifically designed to guide the LLM in analyzing the transcript and generating a structured summary of the interaction. As described herein, a single prompt is used to generate a single output that comprise multiple different data elements, including a sentiment indicator, a disposition status, and a conversation summary. However, those skilled in the art will recognize that the same output could be achieved using multiple prompts.

At method operation 1206, the LLM receives the prompt and processes the provided transcript according to the specified instructions. Utilizing its advanced understanding of language and context, the LLM generates a wrap-up summary of the communication session. This summary includes data elements such as a sentiment indicator, which reflects the emotional tone of the conversation; a disposition status, summarizing the primary reason or objective behind the customer's communication request; and a detailed conversation summary, highlighting points, inquiries, and resolutions discussed during the session. The generated wrap-up summary is then presented to the agent, at operation 1208, through a user interface designed for post-communication review. This interface allows the agent to see a concise yet comprehensive overview of the interaction, enabling them to grasp the customer's sentiment, the interaction's disposition, and the conversation's substantive content at a glance. Importantly, the user interface provides functionality for the agent to edit the wrap-up summary. This feature acknowledges the agent's firsthand experience of the interaction, allowing them to refine the LLM-generated content to ensure that the final documentation accurately reflects the nuances and outcomes of the conversation.

Accordingly, at method operation 1210, one or more edits are received, before input is received, at operation 1212, instructing the system to save the final version of the wrap-up summary.

### Machine Architecture

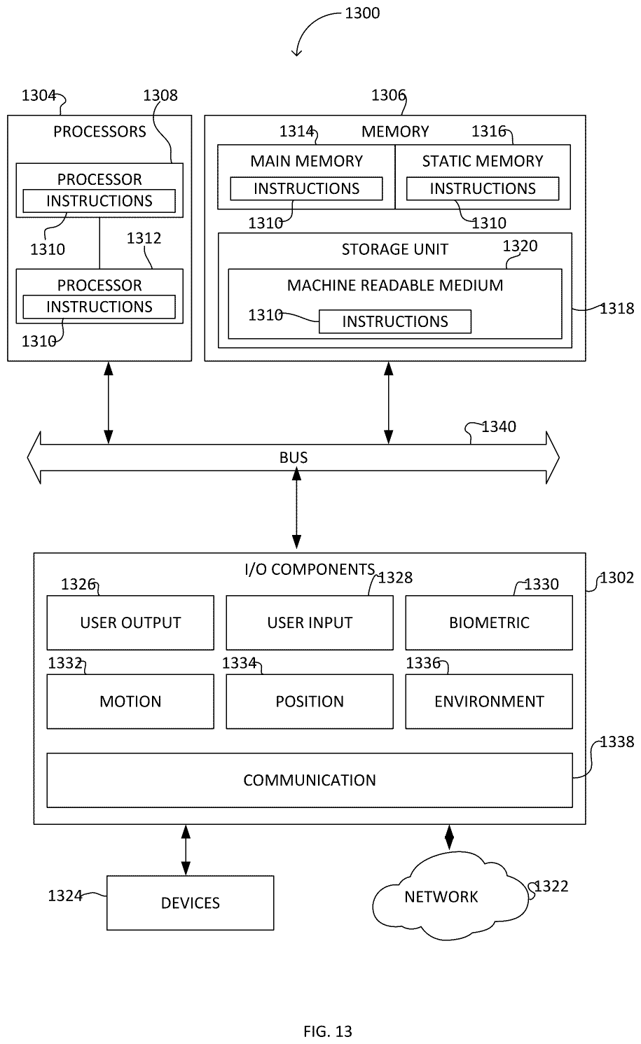

FIG. 13 is a diagrammatic representation of a machine 1300—sometimes referred to as a computing device—within which instructions 1310 (e.g., software, a program, an application or app, or other executable code) for causing the machine 1300 to perform any one or more of the methodologies discussed herein may be executed. For example, the instructions 1310 may cause the machine 1300 to execute any one or more of the methods described herein. The instructions 1310 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine (e.g., client computing device) in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1310, sequentially or otherwise, that specify actions to be taken by the machine 1300. Further, while a single machine 1300 is illustrated, the term “machine” shall also be taken to include a collection of machines that individually or jointly execute the instructions 1310 to perform any one or more of the methodologies discussed herein. The machine 1300, for example, may comprise the client machine(s) 310 or any one of multiple server devices forming part of the customer data platform 300. In some examples, the machine 1300 may also comprise both client and server systems, with certain operations of a particular method or algorithm being performed on the server-side and with certain operations of the particular method or algorithm being performed on the client-side.

The machine 1300 may include processors 1304, memory 1306, and input/output I/O components 1302, which may be configured to communicate with each other via a bus 1340. In an example, the processors 1304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 13013 and a processor 1312 that execute the instructions 1310. The term “processor” is intended to include multi-core processors that may comprise two or more independent processors (sometimes referred to as “cores”) that may execute instructions contemporaneously. Although FIG. 13 shows multiple processors 1304, the machine 1300 may include a single processor with a single-core, a single processor with multiple cores (e.g., a multi-core processor), multiple processors with a single core, multiple processors with multiples cores, or any combination thereof.

The memory 1306 includes a main memory 1314, a static memory 1316, and a storage unit 13013, all accessible to the processors 1304 via the bus 1340. The main memory 1306, the static memory 1316, and storage unit 13113 store the instructions 1310 embodying any one or more of the methodologies or functions described herein. The instructions 1310 may also reside, completely or partially, within the main memory 1314, within the static memory 1316, within machine-readable medium 1320 within the storage unit 13113, within at least one of the processors 1304 (e.g., within the processor's cache memory), or any suitable combination thereof, during execution thereof by the machine 1300.

The I/O components 1302 may include a wide variety of components to receive input, provide output, produce output, transmit information, exchange information, capture measurements, and so on. The specific I/O components 1302 that are included in a particular machine will depend on the type of machine. For example, portable machines such as mobile phones may include a touch input device or other such input mechanisms, while a headless server machine will likely not include such a touch input device. It will be appreciated that the I/O components 1302 may include many other components that are not shown in FIG. 13. In various examples, the I/O components 1302 may include user output components 1326 and user input components 13213. The user output components 1326 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 13213 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1302 may include biometric components 1330, motion components 1332, environmental components 1336, or position components 1334, among a wide array of other components. For example, the biometric components 1330 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1332 include acceleration sensor components (e.g., accelerometer), gravitation sensor components, rotation sensor components (e.g., gyroscope).

The environmental components 1336 include, for example, one or more image sensors or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1334 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1302 further include communication components 13313 operable to couple the machine 1300 to a network 1322 or devices 1324 via respective coupling or connections. For example, the communication components 13313 may include a network interface component or another suitable device to interface with the network 1322. In further examples, the communication components 13313 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1324 may be another machine or any of a wide variety of peripheral devices (e.g., a peripheral device coupled via a USB).

Moreover, the communication components 13313 may detect identifiers or include components operable to detect identifiers. For example, the communication components 1313 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 13313, such as location via Internet Protocol (IP) geolocation, location via Wi-Fi® signal triangulation, location via detecting an NFC beacon signal that may indicate a particular location, and so forth.

The various memories (e.g., main memory 1314, static memory 1316, and memory of the processors 1304) and storage unit 1313 may store one or more sets of instructions and data structures (e.g., software) embodying or used by any one or more of the methodologies or functions described herein. These instructions (e.g., the instructions 1310). when executed by processors 1304, cause various operations to implement the disclosed examples.

The instructions 1310 may be transmitted or received over the network 1322, using a transmission medium, via a network interface device (e.g., a network interface component included in the communication components 13313) and using any one of several well-known transfer protocols (e.g., hypertext transfer protocol (HTTP)). Similarly, the instructions 1310 may be transmitted or received using a transmission medium via a coupling (e.g., a peer-to-peer coupling) to the devices 1324.

### Software Architecture

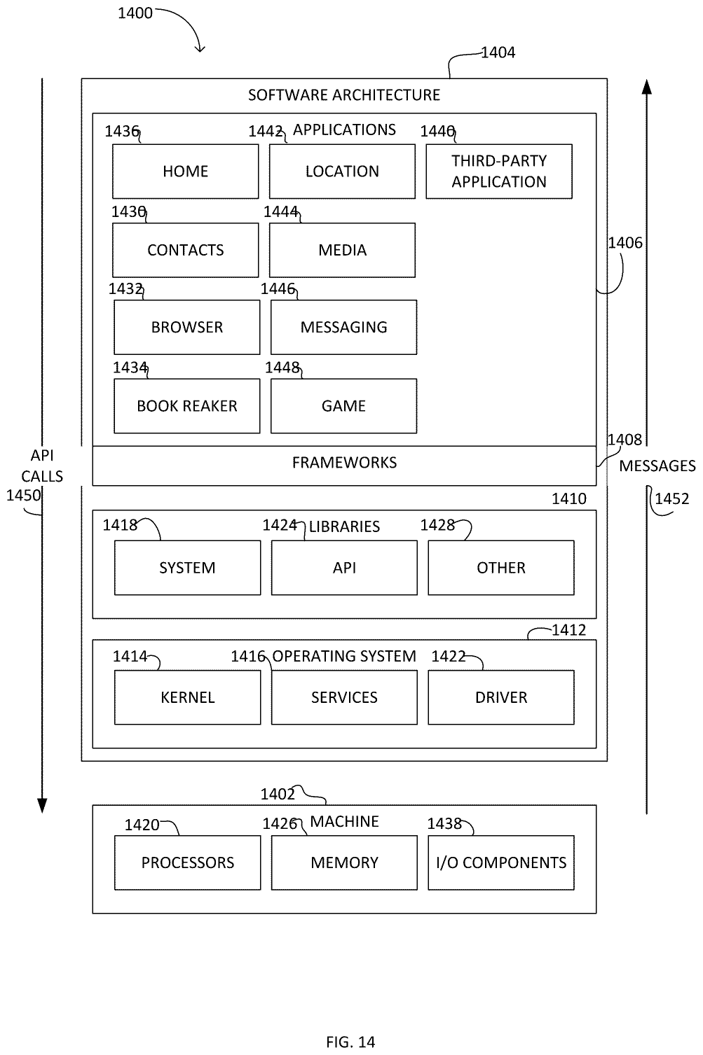

FIG. 14 is a block diagram 1400 illustrating a software architecture 1404, which can be installed on any one or more of the devices described herein. The software architecture 1404 is supported by hardware such as a machine 1402 that includes processors 1420, memory 1426, and I/O) components 1438. In this example, the software architecture 1404 can be conceptualized as a stack of layers, where each layer provides a particular functionality. The software architecture 1404 includes layers such as an operating system 1412, libraries 1410, frameworks 1408, and applications 1406. Operationally, the applications 1406 invoke API calls 1450 through the software stack and receive messages 1452 in response to the API calls 1450.

The operating system 1412 manages hardware resources and provides common services. The operating system 1412 includes, for example, a kernel 1414, services 1416, and drivers 1422. The kernel 1414 acts as an abstraction layer between the hardware and the other software layers. For example, the kernel 1414 provides memory management, processor management (e.g., scheduling), component management, networking, and security settings, among other functionalities. The services 1416 can provide other common services for the other software layers. The drivers 1422 are responsible for controlling or interfacing with the underlying hardware. For instance, the drivers 1422 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1410 provide a common low-level infrastructure used by the applications 1406. The libraries 1410 can include system libraries 1418 (e.g., C standard library) that provide functions such as memory allocation functions, string manipulation functions, mathematic functions, and the like. In addition, the libraries 1410 can include API libraries 1424 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1410 can also include a wide variety of other libraries 1428 to provide many other APIs to the applications 1406.

The frameworks 1408 provide a common high-level infrastructure that is used by the applications 1406. For example, the frameworks 1408 provide various graphical user interface (GUI) functions, high-level resource management, and high-level location services. The frameworks 1408 can provide a broad spectrum of other APIs that can be used by the applications 1406, some of which may be specific to a particular operating system or platform.

In an example, the applications 1406 may include a home application 1436, a contacts application 1430, a browser application 1432, a book reader application 1434, a location application 1442, a media application 1444, a messaging application 1446, a game application 1448, and a broad assortment of other applications such as a third-party application 1440. The applications 1406 are programs that execute functions defined in the programs. Various programming languages can be employed to create one or more of the applications 1406, structured in a variety of manners, such as object-oriented programming languages (e.g., Objective-C, Java, or C++) or procedural programming languages (e.g., C or assembly language). In a specific example, the third-party application 1440 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1440 can invoke the API calls 1450 provided by the operating system 1412 to facilitate functionalities described herein.

What is claimed, is:

1. A computer-implemented method for providing a customer profile summary to an agent in a digital engagement service, the method comprising:
in response to receiving an incoming communication request from a customer, the incoming communication requesting including a customer identifier, initiating a process to generate a customer profile summary based on customer profile data associated with the customer identifier, the process comprising:
querying a customer data platform (CDP) to retrieve customer profile data associated with the customer identifier;
generating a prompt for use as input to a large language model (LLM), the prompt including at least an instruction and context data, the instruction formulated to instruct the LLM to analyze the customer profile data included in the context data and to generate a customer profile summary based on the customer profile data;
receiving as output from the LLM the customer profile summary; and
presenting via a user interface of an agent dashboard of an available agent the customer profile summary.

2. The computer-implemented method of claim 1, wherein querying the CDP further comprises:
utilizing a profile connector to map the customer identifier to a system-generated unique identifier (ID) for the customer, wherein the customer identifier is selected from the group consisting of a phone number, a username, an email address, an instant messaging (IM) handle, and a social media account name; and
transmitting the system-generated unique ID to the CDP to retrieve a set of customer attributes associated with the system-generated unique ID and a set of customer events associated with the system-generated unique ID, wherein the profile connector operates to facilitate translation between the customer identifier and the system-generated unique ID to ensure accurate retrieval of customer data from the CDP.

3. The computer-implemented method of claim 2, wherein the instruction formulated for the LLM further specifies a maximum length for the customer profile summary to be generated by the LLM.

4. The computer-implemented method of claim 3, wherein the maximum length is defined in terms of a number of words, characters, or sentences.

5. The computer-implemented method of claim 1, further comprising: incorporating into the context data for the prompt a text-based transcript of a prior communication session with the customer, wherein the prior communication session was with a first agent and the inclusion of the text-based transcript enables the LLM to enhance the generation of the customer profile summary by considering the content of the prior communication session in addition to the customer profile data.

6. The computer-implemented method of claim 5, wherein the text-based transcript includes a description of a specific customer need or inquiry expressed during the prior communication session, and the LLM utilizes this description to prioritize relevant aspects of the customer profile data in the generation of the customer profile summary.

7. The computer-implemented method of claim 1, further comprising: incorporating into the context data for the prompt a text-based transcript of a prior communication session with the customer, wherein the prior communication session was with an automated chatbot and the inclusion of the text-based transcript enables the LLM to enhance the generation of the customer profile summary by considering the content of the prior communication session in addition to the customer profile data.

8. The computer-implemented method of claim 3, wherein presenting the customer profile summary to the agent further comprises:
displaying the customer profile summary within a graphical user interface (GUI) of an agent dashboard, wherein the customer profile summary is visually distinguished from other elements within the GUI to draw attention of the agent; and
organizing the customer profile summary in the GUI based on a predetermined hierarchy of information importance, such that customer details are presented prominently at the top of the customer profile summary, enabling the agent to grasp key aspects of the customer's profile summary at a glance before accepting the incoming communication request.

9. A system for providing a customer profile summary to an agent using a digital engagement service, the system comprising:
one or more processors;
a memory storage device storing instructions thereon, which, when executed by the one or more processors, cause the system to perform operations comprising:
in response to receiving an incoming communication request from a customer, the incoming communication requesting including a customer identifier, initiating a process to generate a customer profile summary based on customer profile data associated with the customer identifier, the process comprising:
querying a customer data platform (CDP) to retrieve customer profile data associated with the customer identifier;
generating a prompt for use as input to a large language model (LLM), the prompt including at least an instruction and context data, the instruction formulated to instruct the LLM to analyze the customer profile data included in the context data and to generate a customer profile summary based on the customer profile data;
receiving as output from the LLM the customer profile summary; and
storing in a data store the customer profile summary;
presenting via a user interface of an agent dashboard of an available agent the customer profile summary.

10. The system of claim 9, wherein querying the CDP further comprises:
utilizing a profile connector to map the customer identifier to a system-generated unique identifier (ID) for the customer, wherein the customer identifier is selected from the group consisting of a phone number, a username, an email address, an instant messaging (IM) handle, and a social media account name; and
transmitting the system-generated unique ID to the CDP to retrieve a set of customer attributes associated with the system-generated unique ID and a set of customer events associated with the system-generated unique ID, wherein the profile connector operates to facilitate translation between the customer identifier and the system-generated unique ID to ensure accurate retrieval of customer data from the CDP.

11. The system of claim 10, wherein the instruction formulated for the LLM further specifies a maximum length for the customer profile summary to be generated by the LLM.

12. The system of claim 11, wherein the maximum length is defined in terms of a number of words, characters, or sentences.

13. The system of claim 9, wherein the operations further comprise:
incorporating into the context data for the prompt a text-based transcript of a prior communication session with the customer, wherein the prior communication session was with a first agent and the inclusion of the text-based transcript enables the LLM to enhance the generation of the customer profile summary by considering the content of the prior communication session in addition to the customer profile data.

14. The system of claim 13, wherein the text-based transcript includes a description of a specific customer need or inquiry expressed during the prior communication session, and the LLM utilizes this description to prioritize relevant aspects of the customer profile data in the generation of the customer profile summary.

15. The system of claim 9, wherein the operations further comprise:
incorporating into the context data for the prompt a text-based transcript of a prior communication session with the customer, wherein the prior communication session was with an automated chatbot and the inclusion of the text-based transcript enables the LLM to enhance the generation of the customer profile summary by considering the content of the prior communication session in addition to the customer profile data.

16. The system of claim 11, wherein presenting the customer profile summary to the agent further comprises:
displaying the customer profile summary within a graphical user interface (GUI) of an agent dashboard, wherein the customer profile summary is visually distinguished from other elements within the GUI to draw the attention of the agent; and
organizing the customer profile summary in the GUI based on a predetermined hierarchy of information importance, such that customer details are presented prominently at the top of the customer profile summary, enabling the agent to grasp key aspects of the customer's profile summary at a glance before accepting the incoming communication request.

17. A machine-readable storage medium storing instructions thereon, which, when executed by one or more processors, cause a system to perform operations comprising:
in response to receiving an incoming communication request from a customer, the incoming communication requesting including a customer identifier, initiating a process to generate a customer profile summary based on customer profile data associated with the customer identifier, the process comprising:
querying a customer data platform (CDP) to retrieve customer profile data associated with the customer identifier;
generating a prompt for use as input to a large language model (LLM), the prompt including at least an instruction and context data, the instruction formulated to instruct the LLM to analyze the customer profile data included in the context data and to generate a customer profile summary based on the customer profile data;
receiving as output from the LLM the customer profile summary; and
storing in a data store the customer profile summary;
presenting via a user interface of an agent dashboard of an available agent the customer profile summary.

18. The machine-readable medium of claim 17, wherein querying the CDP further comprises:
utilizing a profile connector to map the customer identifier to a system-generated unique identifier (ID) for the customer, wherein the customer identifier is selected from the group consisting of a phone number, a username, an email address, an instant messaging (IM) handle, and a social media account name; and
transmitting the system-generated unique ID to the CDP to retrieve a set of customer attributes associated with the system-generated unique ID and a set of customer events associated with the system-generated unique ID, wherein the profile connector operates to facilitate translation between the customer identifier and the system-generated unique ID to ensure accurate retrieval of customer data from the CDP.

19. The machine-readable medium of claim 17, wherein the instruction formulated for the LLM further specifies a maximum length for the customer profile summary to be generated by the LLM.

20. The machine-readable medium of claim 18, further comprising:
placing the incoming communication request in a queue for assignment to an available agent, and initiating an asynchronous process to generate and store the customer profile summary based on the customer profile data associated with the customer identifier, wherein the asynchronous process includes querying the customer data platform (CDP) to retrieve customer profile data, generating a prompt for use as input to a large language model (LLM), receiving the customer profile summary as output from the LLM, and storing the customer profile summary in a data store; and
when an agent becomes available, processing the queued communication request by generating an invitation to accept the incoming communication request, wherein the invitation is presented via a user interface of an agent dashboard and includes the customer profile summary obtained from the data store, thereby ensuring that the agent is equipped with relevant customer insights prior to engaging with the customer.
